(19) United States
(12) Patent Application Publication
(10) Pub. No.: US 2008/0124043 A1
(43) Pub. Date: May 29, 2008

(54) Multiplexing apparatus, multiplexing method, and computer product

(75) Inventor: Tomonori Honjo, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/653,925

(22) Filed: Jan. 17, 2007

(30) Foreign Application Priority Data
Aug. 18, 2006 (JP) 2006-223082

(51) Int. Cl. H04N 7/087

(52) U.S. Cl. 386/84

(57) ABSTRACT

A multiplexing apparatus includes a DEMUX that divides input content data into compressed video data and compressed audio data, a VIDEO DEC that expands the compressed video data, a VIDEO ENC that converts the video data expanded by the VIDEO DEC into a predetermined data format, an ASIN that writes synchronization information to synchronize the video data converted by the VIDEO ENC, and a MUX that generates stream data by multiplexing the video data converted by the VIDEO ENC and the compressed audio data based on the synchronization information.

### CROSS-REFERENCE TO RELATED APPLICATIONS

This application is based upon and claims the benefit of priority from the prior Japanese Patent Application No. 2006-223082, filed on Aug. 18, 2006, the entire contents of which are incorporated herein by reference.

### BACKGROUND OF THE INVENTION

1. Field of the Invention

The present invention relates to a technology for multiplexing data to generate stream data.

2. Description of the Related Art

Conventionally, content data that simultaneously reproduces video and audio is recorded with video data and audio data integrated. In this type of content data, focus is mainly put on recording the video data, and a recording capacity for the audio data is often set low.

Therefore, improvement in sound quality of the audio data and attachment of character information, such as the name of a song corresponding to the audio data have not been possible. A reproduction time of the audio data could not be individually managed since the audio data was recorded in association with the video data. Apparatuses facilitating the time management of the audio data and attachment of information are disclosed for the content data, focusing on recording of the audio data (for example, Japanese Patent Application Laid-Open Publication No. H11-219579).

Recently, content data is distributed or provided by multiplexing independent video data and audio data. In this type of content data, the video data and the audio data can be synchronized and reproduced according to a configuration of multiplexing. A technology is disclosed that a user arbitrarily processes the independent video data and audio data, enabling synchronization and reproduction of the data as before the processing (for example, Japanese Patent Application Laid-Open Publication No. 2000-195231).

For the content data with independent video data and audio data, changes in a format or in a compression method for each data can be independently conducted. For example, in an apparatus that receives content data from a broadcast satellite (BS) and terrestrial digital broadcast wave and that records the received data, a process of converting the data format of only the video data, and multiplexing the video data again with the audio data, and forming data, such as transport stream, that is easy to be handled.

FIG. 1 is a block diagram of a conventional multiplexing apparatus that generates a transport stream from BS or terrestrial digital broadcast. One example of a specific process when generating a transport stream will be described with reference to FIG. 1. A multiplexing apparatus 400 includes a BS/terrestrial digital tuner 410, a codec large-scale integration (LSI) 420, and a Sony/Philips digital interface format (SPDIF) decoder 430.

The BS/terrestrial digital tuner 410 receives the BS/terrestrial digital broadcast wave to acquire content data. The BS/terrestrial digital tuner 410 is further equipped with a DEMUX 411 and a video decoder (VIDEO DEC) 412 and conducts a process to treat the video data and audio data as independent data.

Specifically, the demultiplexer (DEMUX) 411 first divides the content data acquired by the BS/terrestrial digital tuner 410 into video data and audio data. The content data distributed as a broadcast wave is data compressed by a predetermined method. Therefore, the divided video data and audio data also are compressed data.

The divided video data is then input into the VIDEO DEC 412 and expanded to a normal sized video data. The expanded video data is input from the VIDEO DEC 412 to the codec LSI 420. An example of using an SPDIF as a general format of the audio data multiplexed to a broadcast wave will be described here. The divided audio data is first output from the DEMUX 411 as audio data compressed with SPDIF standard and input to the SPDIF decoder 430.

After expanding the input audio data, the SPDIF decoder 430 outputs the data as a signal of linear pulse code modulation (LPCM). The LPCM is a conversion method of digital data and converts data to a pulse signal in compliance with a predetermined standard without compressing.

The codec LSI 420 conducts a process of generating a transport stream by multiplexing the independent video data and audio data. Specifically, the codec LSI 420 is equipped with a video encoder (VIDEO ENC) 421, an AIN audio encoder (AUDIO ENC) 422, and a multiplexer (MUX) 423.

The video data is input into the VIDEO ENC 421 from the VIDEO DEC 412 of the BS/terrestrial digital tuner 410. The VIDEO ENC 421 converts the input video data to video data for transport stream and outputs the data to the MUX 423.

Audio data of the LPCM is input from the SPDIF decoder 430 to the AIN AUDIO ENC 422. The AIN AUDIO ENC 422 converts the input audio data to audio data for transport stream and outputs the data to the MUX 423.

The MUX 423 multiplexes the video data input from the VIDEO ENC 421 and the audio data input from the AIN AUDIO ENC 422 and outputs the data as a transport stream (TS). Expanded data of the video data and the audio data multiplexed by the MUX 423 is converted (encoded) to data for transport stream. Therefore, even if the video data and audio data after conversion are multiplexed without change, the data can easily be synchronized.

FIG. 2 is a timing chart of a synchronization process by the conventional multiplexing apparatus. The codec LSI 420 of FIG. 2 is encoded at (A), corresponding to ON/OFF of a pause state. Signals indicative of timing of video synchronization periodically flow at (B) since a configuration of the video data is the standard upon synchronization process.

At (C), the video data is sequentially reproduced in the order of video data Vn−1, video data Vn, and video data Vn+1 for each of “burst” indicative of a predetermined data amount. The signals of the video synchronization at B are configured so that the ON signals overlap at the top of each data (e.g., video data Vn) based on the bursts.

At (D), compressed audio data indicates audio data before input into the SPDIF decoder 430. At (E), LPCM audio data indicates audio data expanded and encoded by the SPDIF decoder 430. At (E), the LPCM audio data is delayed for a fixed value compared to the (D) compressed audio data since the LPCM audio data is expanded and encoded by the SPDIF decoder 430.

The time required for expanding and encoding at the SPDIF decoder 430 is standardized. In other words, the fixed value indicating a delay of the (E) LPCM audio data is a known value. The video data and the LPCM audio data can easily be synchronized since how long the LPCM audio data An is delayed compared to the video data Vn when releasing the pause can be referenced.

However, in a multiplexing apparatus 400 as in FIG. 1, although conversion of the data format of only the video data is desired, a process of expanding the audio data as well as the video data from the compressed state is conducted since the data is synchronized as a transport stream. As a result, the conventional technology must include a decode process of audio data (process of SPDIF decoder 430) and an encode process associated with the decode process (process of AIN AUDIO ENC 422) that are normally unnecessary. Therefore, the processes of the multiplexing apparatus became complicated.

As described, expansion and compression of the compressed audio data received as a broadcast wave needs to be conducted with unnecessary decode process and encode process. Therefore, in some cases, quality of the audio data of the transport stream multiplexed again is deteriorated due to expansion and compression.

Assume that the decode process of audio data is excluded and the multiplexing apparatus 400 such as the one in FIG. 1 has a configuration that the video data and the compressed audio data are multiplexed from the beginning. Even with this configuration, as is apparent from the comparison between (C) video data and (D) compressed audio data of FIG. 2, the delay relationship between the (C) video data and the (D) compressed audio data cannot be indicated by a fixed value. Therefore, the delay time of the (C) video data and the (D) compressed audio data cannot be synchronized as the (C) video data and the (E) LPCM audio data.

Unlike the (E) LPCM audio data, the (C) compressed audio data cannot be abandoned halfway at an arbitrary timing since the data is compressed with reference to the differences of data in a same burst. Thus, multiplexing in which synchronization of expanded uncompressed video data and compressed audio data is easily done is difficult to be achieved.

### SUMMARY OF THE INVENTION

It is an object of the present invention to at least solve the above problem in the conventional technologies.

A multiplexing apparatus according to one aspect of the present invention includes a dividing unit that divides input data into compressed video data and compressed audio data; an expanding unit that expands the compressed video data; a converting unit that converts the data video data expanded by the expanding unit into a predetermined format; a writing unit that writes synchronization information into the compressed audio data, the synchronization information to synchronize the converted video data; and a multiplexing unit that multiplexes the converted video data and the compressed audio data in which the synchronization information is written, to generate stream data.

A multiplexing method according to another aspect of the present invention includes dividing input data into compressed video data and compressed audio data; expanding the compressed video data; converting the data video data expanded by the expanding unit into a predetermined format; writing synchronization information into the compressed audio data, the synchronization information to synchronize the converted video data; and multiplexing the converted video data and the compressed audio data in which the synchronization information is written, to generate stream data.

A computer-readable recording medium according to still another aspect of the present invention stores therein a multiplexing program making a computer execute the multiplexing method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a conventional multiplexing apparatus that generates a transport stream from BS/terrestrial digital broadcast;

FIG. 2 is a timing chart of a synchronization process by the conventional multiplexing apparatus;

FIG. 3 is a block diagram of a multiplexing apparatus of an embodiment of the present invention;

FIG. 4 is a timing chart for explaining a configuration of image data and compressed audio data to be multiplexed; and

FIG. 5 is a schematic for illustrating a frame configuration of the compressed audio data.

### DETAILED DESCRIPTION OF THE PREFERRED EMBODIMENTS

Exemplary embodiments according to the present invention will be explained in detail below with reference to the accompanying drawings.

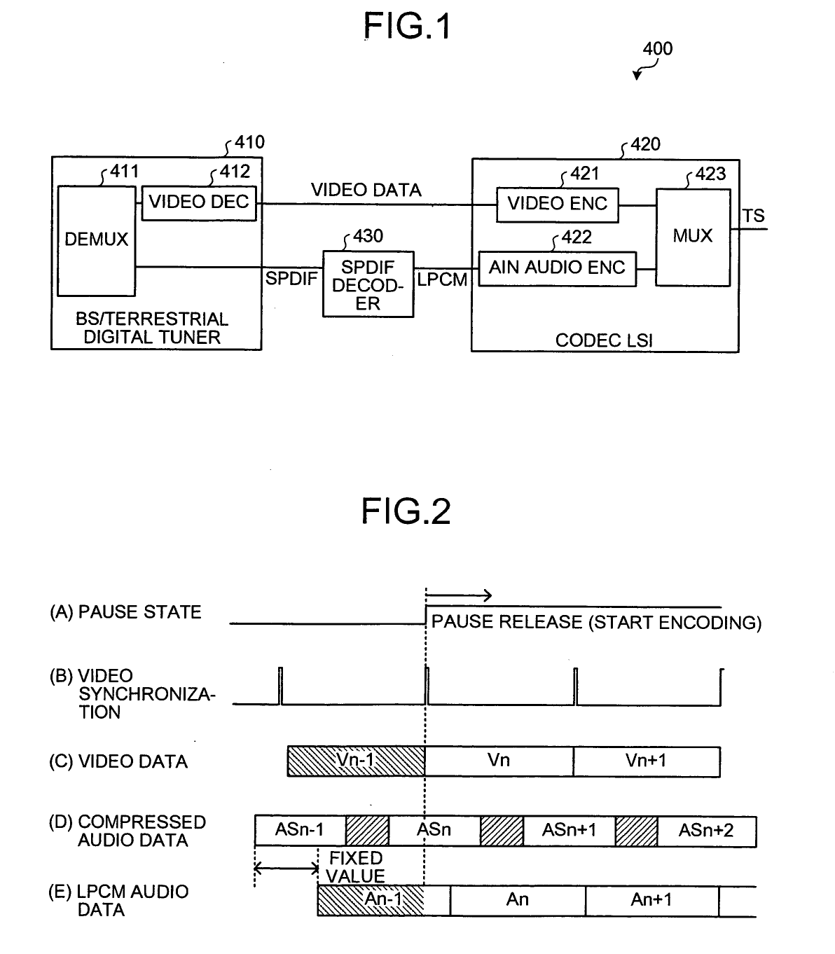

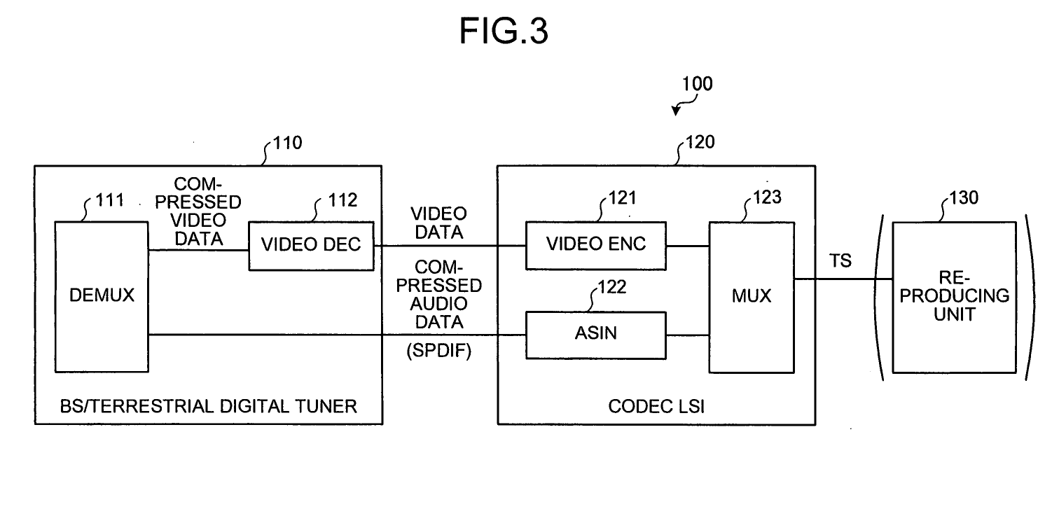

FIG. 3 is a block diagram of a multiplexing apparatus according to an embodiment of the present invention. As shown in FIG. 1, a multiplexing apparatus 100 includes a BS/terrestrial digital tuner 110 and a codec LSI 120.

The BS/terrestrial digital tuner 110 receives a broadcast wave and acquires content data. The BS/terrestrial digital tuner 110 further divides the acquired content data into video data and audio data and outputs the data to the codec LSI 120. To conduct the process, the BS/terrestrial digital tuner 110 is configured to include a DEMUX 111 as a dividing unit and a VIDEO DEC 112 as an expanding unit.

Specifically, the acquired content data is data multiplexed with video data and audio data compressed in compliance with a predetermined standard. Data compressed in compliance with a standard of SPDIF will be described here as an example. The DEMUX 111 first divides the content data into compressed video data and compressed audio data. The compressed video data that is one of the divided data is input to the VIDEO DEC 112. The compressed audio data that is the other of the divided data is input to the codec LSI 120.

The VIDEO DEC 112 expands the compressed video data input from the DEMUX 111. The expanded video data is input to the codec LSI 120 as normal (uncompressed) video data.

The codec LSI 120 multiplexes the video data and the compressed audio data input from the BS/terrestrial digital tuner 110 and outputs the data as a transport stream (TS). To conduct the process, the codec LSI 120 includes a VIDEO ENC 121 as a converting unit, an ASIN (compressed audio data input unit) 122 as a writing unit, and a MUX 123 as a multiplexing unit.

Specifically, the VIDEO ENC 121 converts the video data for transport stream that is input from the VIDEO DEC 112 of the BS/terrestrial digital tuner 110. The converted video data is input to the MUX 123.

The ASIN 122 conducts a process of synchronizing the video data to the compressed audio data input from the DEMUX 111 of the BS/terrestrial digital tuner 110. The process of synchronizing is a process of writing predetermined synchronization information to the compressed audio data. For example, a starting timing and a specific time of reproduction of the compressed audio data are written on the compressed audio data. With the writing of the synchronization information, a process of finding how long the compressed audio data is delayed or preceded compared to the audio data can be conducted when the audio data and the compressed audio data are synchronized. A specific content of the synchronization information and a specific synchronization process will be described later.

The MUX 123 multiplexes the video data input from the VIDEO ENC 121 and the compressed audio data input from the ASIN 122. The multiplexed data is output as a transport stream (TS).

As described, the multiplexing apparatus 100 is configured to conduct predetermined decode process and encode process only to the video data whose format is to be converted. The audio data of which the data format is not necessary to be converted is again multiplexed with the video data by the codec LSI 120 without changing the state of the compressed audio data multiplexed as content data acquired by the BS/terrestrial digital tuner 110.

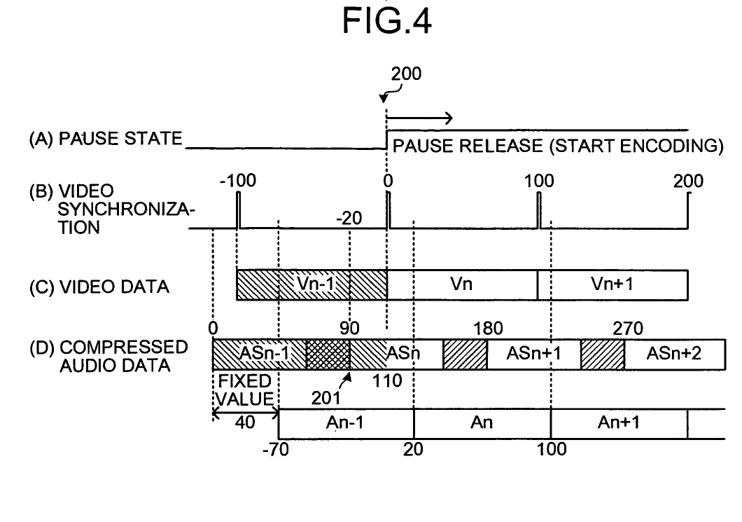

By excluding a function unit that conducts the decode process and the encode process of the audio data from a conventional multiplexing apparatus (e.g., multiplexing apparatus 400 of FIG. 4), the multiplexing apparatus 100 can be provided in a simpler configuration than a conventional apparatus. Deterioration of the audio data caused by repetition of the decode process and the encode process can also be prevented.

FIG. 4 is a timing chart for explaining a configuration of image data and compressed audio data to be multiplexed. FIG. 4 illustrates, in same time axes, (A) pause state indicative of ON/OFF of the pause state, (B) video synchronization indicative of a signal for synchronization based on video data, (C) video data indicative of contents of image data Vn, and (D) compressed audio data indicative of contents of compressed audio data ASn.

The MUX 123 shown in FIG. 3 multiplexes (D) compressed audio data as in FIG. 4 with video data (precisely, video data converted for transport stream) without change. As described, unlike uncompressed data, the compressed audio data cannot be reproduced or abandoned in the middle of the data.

Therefore, when pause release 200 is instructed, which of compressed audio data ASn−1 and compressed audio data ASn that are close to the pause release 200 will be multiplexed first is determined with reference to the synchronization information (pause information and time stamp information) written on the compressed audio data. The ASIN 122 conducts the writing process of the synchronization information.

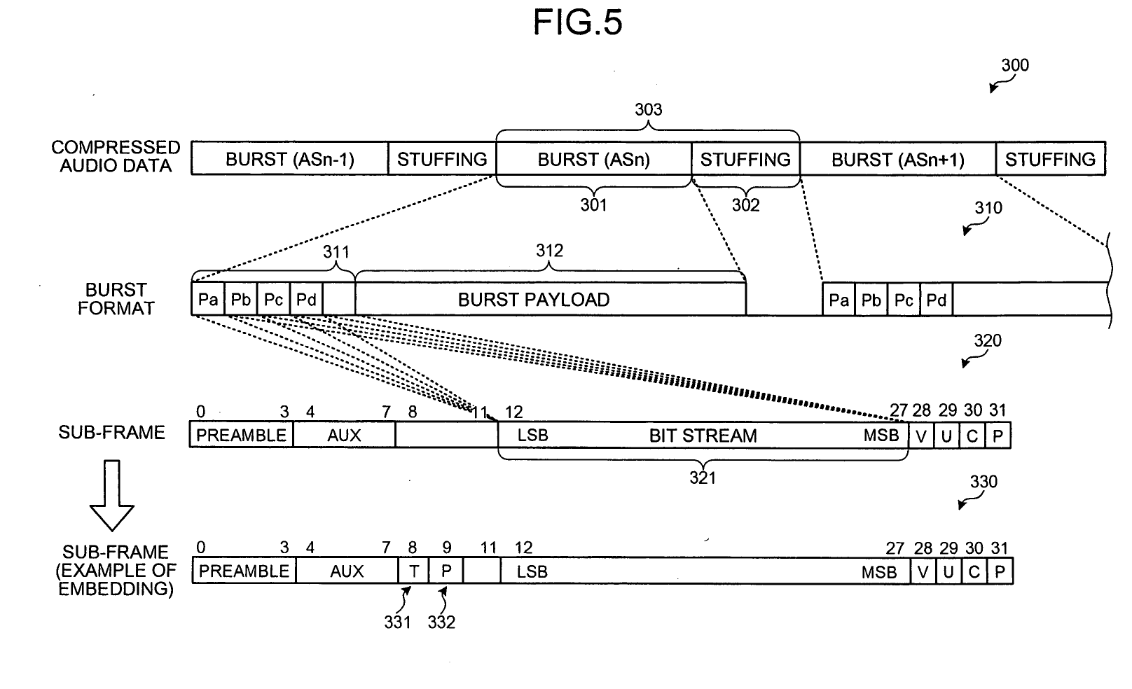

FIG. 5 is a schematic for illustrating a frame configuration of compressed audio data. In compressed audio data 300 shown in FIG. 3, compressed audio data (compressed audio data ASn−1, compressed audio data ASn, compressed audio data ASn+1) is arranged for each burst 301 of each predetermined data size.

A stuffing 302 arranged immediately after the burst 301 indicates a data part reduced by compression. The stuffing 302 is arranged at the data part reduced by compression and serves to eliminate lack of bits of a frame. The audio data before compression is equivalent to a data size 303 that is an addition of the burst 301 and the stuffing 302.

A burst format 310 indicates a further detailed configuration of the burst 301 of the compression audio data 300. As shown in FIG. 5, the burst format 310 is constituted by headers 311, such as Pa, that includes format information and a burst payload 312 that includes actual compressed audio data.

A sub-frame 320 indicates a configuration upon actual multiplexing of the compressed audio data as a transport stream. The headers 311 of the burst format 310 are stored in an LSB and an MSB of a bit stream 321 of the sub-frame 320 as bi-phase. The configuration of the sub-frame 320 is a general configuration of when multiplexing the uncompressed audio data as a transport stream.

In the embodiment, synchronization information is written at unused packet parts [8, 9] of the sub-frame 320 to synchronize the video data and the compressed audio data. Examples of the synchronization information that can be written include time stamp information 331 and pause information 332 illustrated at the sub-frame 320.

The time stamp information 331 is information indicative of a reproduction start time of the compressed audio data. The video data and the compressed audio data are synchronized and reproduced by finding a time difference in reproduction start times of the video data and the compressed data based on the time stamp information.

The pause information 332 is information indicative of a reproduction start timing of the compressed audio data. The video data and the compressed audio data are synchronized and reproduced by finding an interval between reproduction start timings of the video data and the compressed audio data. In the embodiment, the sub-frame 320 that the synchronization information is written to is multiplexed as a transport stream.

As described, in the multiplexing apparatus 100, the ASIN 122 writes synchronization information to the compressed audio data. Multiplexing the compressed audio data to the video data enables to easily generate a transport stream that can be synchronized. When writing the synchronization information, the synchronization information can easily be applied to the currently used content data since a so-called option unit of the existing data format is used.

Intervals of ON signals of video synchronization shown in (A) of FIG. 4 are set for each 100 [clocks (unit is not limited to this)] in accordance with video data Vn−1, video data Vn, and video data Vn+1 shown in the (C) video data.

### <When Using Pause Information>

The pause information is written on headers (0, 90, 180, and 270 [clocks]) of compressed audio data ASn−1, compressed audio data ASn, compressed audio data ASn+1, and compressed audio data ASn+2 shown at (D) compressed audio data.

For example, of the intervals of ON signals of the (B) video synchronization, when encoding is started from the pause release 200 of the (A) pause state, pause information stored in the header 201 of the compressed audio data ASn read at the last prior to the pause release 200 is referenced from the (D) compressed audio data to synchronize the video data Vn and the compressed audio data ASn.

At “video synchronization”, by finding the difference between the timing of the pause information of the header 201 and the timing of the pause release 200, it can be automatically recognized that the delay interval of the video data Vn and the compressed audio data ASn is 20 [clocks]. In this way, how much interval the compressed audio data ASn is delayed (or preceded) from the video data Vn can be found. Therefore, the compressed audio data can be synchronized with the video data by reproducing the compressed audio data late or in advance for the interval found with the process.

### <When Using Time Stamp Information>

Similar to the pause information, the time stamp information is also written on headers (0, 90, 180, and 270) of compressed audio data ASn−1, compressed audio data ASn, compressed audio data ASn+1, and compressed audio data Asn+2 shown at the (D) compressed audio data.

As shown in FIG. 4, the (C) video data synchronizes with the ON signal of the (B) video synchronization for each 100 [clocks] in accordance with the data size of the video data Vn. The time stamp information is written on the (D) compressed audio data for each of 90 [clocks] in accordance with the data size of the compressed audio data ASn. The time stamp information is time information having the first compressed audio data ASn−1 as 0. Therefore, time stamp information of the compressed audio data ASn is set 90 [clocks], time stamp information of the compressed audio data ASn+1 is set 180 [clocks], and time stamp information of the compressed audio data ASn+2 is set 270 [clocks].

When the pause release 200 is start encoding, time information of the compressed audio data (time information of the compressed audio data ASn−1 as 0) at the pause release 200 is found using the stamp information with a following Equation 1.

time information (at the time of pause release 200)=TaxC-1+Dt/DaxTw (1)

Ta: frame interval of compressed audio data (90 in the embodiment)

C: number of time stamp information acquisitions

Dt: data size of ASn at the time of pause release 200

Da: data size of entire ASn

Tw: interval of time stamp information (equals to frame interval of compressed audio data)

As a result, time information at the time of pause release 200 is expressed as Equation 2.

$$time information ( at the time of pause release 200 ) = 90 \times 1 + 20 / 90 \times 90 = 110 [ clocks ] \qquad ( 2 )$$

In other words, the time information of the (D) compressed audio data at the time of pause release 200 is 110 [clocks]. When the compressed audio data ASn is expanded to generate uncompressed audio data An, the delay time between the compressed audio data ASn and the uncompressed audio data An is a given value. For one example, the delay time here is a fixed value of 40 [clocks].

Time information PST of the compressed audio data ASn, at the time of pause release 200 as a standard, can be found with following Equation 3.

$$PST = delay time ( fixed value 40 ) - time information ( at the time of pause release 200 ) - time stamp information at the start of ASn = 40 - ( 110 - 90 ) = 20 [ clocks ] \qquad ( 3 )$$

The time information PST of the compressed audio data ASn, at the time of pause release 200 as a standard, is found to be 20 [clocks]. In this way, how much interval the compressed audio data ASn is delayed (or preceded) from the video data Vn can be found. Therefore, the compressed audio data can be synchronized with the video data by reproducing the compressed audio data late or in advance for the interval found in the process.

In the example, the compressed audio data is delayed for 20 [clocks] from the video data. This indicates that reproduction of the compressed audio data ASn is started later than the video data Vn. The delay does not mean a deviation in contents of the video data Vn and the compressed audio data ASn, but means a delay in the reproduction start times of video data Vn and the compressed audio data ASn.

Therefore, if starting of the reproduction of the compressed audio data prior to the video data is desired, multiplexing can be started at the time equivalent to −70 [clocks], pause release 200 as a standard, to multiplex the compressed audio data ASn−1 first (compressed audio data ASn in the example) to the video data Vn.

As described, although more complicated than the synchronization process using the pause information, the synchronization process using the time stamp information enables correct synchronization even when the compressed audio data itself has a defect. Therefore, although the pause information and the time stamp information can separately be used as synchronization information, resistance to errors can be enhanced using both of information.

Although the synchronization process is conducted by devices that received the transport streams output from the multiplexing apparatus 100, a reproducing unit 130 can further be provided in the multiplexing apparatus 100 to reproduce the transport stream generated itself using the synchronization process.

The reproducing unit 130 is equipped with a function of synchronizing and reproducing the video data and the compressed audio data multiplexed to transport streams. For example, the reproducing unit 130 is constituted by an I/F (interface) having a function of synchronizing video data and compressed audio data using synchronization information as described, an audio reproducing unit including a display device, and an output device such as a speaker that are not shown.

As described, the multiplexing apparatus, the multiplexing method, and the multiplexing program of the present invention enables to generate, with a simple process, high-quality stream data that achieves easy synchronization of uncompressed video data and compressed audio data.

In place of the function units 110 to 123 configuring the multiplexing apparatus 100, a read-only memory (ROM) storing a multiplexing program causing to execute processes equivalent to the functions of the function units 110 to 123 may be prepared. The multiplexing method of the present invention may be realized with a software-centered configuration by reading the multiplexing program from the ROM and by a central processing unit (CPU) executing the program.

For another embodiment, a process of the function units 110 to 123 realizing the multiplexing of the present invention may be written on a specific LSI such as an field programmable gate array (FPGA) using an hardware description language (HDL), etc.

The LSI written with the HDL may be provided as a multiplexing apparatus. The LSI may realize the entire processes of the multiplexing apparatus or may realize a part and other parts may be realized by predetermined hardware or a multiplexing program.

Steps of the multiplexing method may be conducted by mixing a function unit having a hardware-centered configuration, a function unit having a software-centered configuration and an LSI written with a specific process. This type of configuration realizes the most efficient multiplexing apparatus in accordance with process contents and user's intention and convenience.

The multiplexing program is recorded on a computer-readable recording medium such as a hard disk, a flexible disk, a compact-disc read-only memory (CD-ROM), a magneto optical (MO) disk, and a digital versatile disc (DVD) and is executed by reading from the recording medium with a computer. The program may also be a transmission medium that is distributable through a network such as the Internet.

According to the embodiments described above, it is possible to generate high quality stream data for which synchronization of the uncompressed video data and the compressed audio data is easily done with a simple process.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A multiplexing apparatus comprising:
a dividing unit that divides input data into compressed video data and compressed audio data;
an expanding unit that expands the compressed video data;
a converting unit that converts the data video data expanded by the expanding unit into a predetermined format;
a writing unit that writes synchronization information into the compressed audio data, the synchronization information to synchronize the converted video data; and
a multiplexing unit that multiplexes the converted video data and the compressed audio data in which the synchronization information is written, to generate stream data.

2. The multiplexing apparatus according to claim 1, wherein the synchronization information includes information indicative of reproduction start timing of the compressed audio data.

3. The multiplexing apparatus according to claim 1, wherein the synchronization information includes time stamp information indicative of reproduction start timing of the compressed audio data.

4. The multiplexing apparatus according to claim 1, further comprising a producing unit that reproduces the stream data, wherein
the reproducing unit synchronizes the converted video data and the compressed audio data multiplexed in the stream data based on the synchronization information.

5. The multiplexing apparatus according to claim 2, further comprising a reproducing unit that reproduces the stream data, wherein
the reproducing unit synchronizes the converted video data and the compressed audio data multiplexed in the stream data based on pause information indicative of the reproduction start timing.

6. The multiplexing apparatus according to claim 3, further comprising a reproducing unit that reproduces the stream data, wherein
the reproducing unit synchronizes the converted video data and the compressed audio data multiplexed in the stream data by calculating time difference between reproduction start timing of the converted video data and the reproduction start timing of the compressed audio data, based on the time stamp information.

7. A multiplexing method comprising:
dividing input data into compressed video data and compressed audio data;
expanding the compressed video data;
converting the data video data expanded by the expanding unit into a predetermined format;
writing synchronization information into the compressed audio data, the synchronization information to synchronize the converted video data; and
multiplexing the converted video data and the compressed audio data in which the synchronization information is written, to generate stream data.

8. The multiplexing method according to claim 7, wherein the synchronization information includes information indicative of reproduction start timing of the compressed audio data.

9. The multiplexing method according to claim 7, wherein the synchronization information includes time stamp information indicative of reproduction start timing of the compressed audio data.

10. The multiplexing method according to claim 7, further comprising producing the stream data while synchronizing the converted video data and the compressed audio data multiplexed in the stream data based on the synchronization information.

11. The multiplexing method according to claim 8, further comprising reproducing the stream data while synchronizing the converted video data and the compressed audio data multiplexed in the stream data based on pause information indicative of the reproduction start timing.

12. The multiplexing method according to claim 9, further comprising reproducing the stream data while synchronizing the converted video data and the compressed audio data multiplexed in the stream data by calculating time difference between reproduction start timing of the converted video data and the reproduction start timing of the compressed audio data, based on the time stamp information.

13. A computer-readable recording medium that stores therein a multiplexing program making a computer execute:
dividing input data into compressed video data and compressed audio data;
expanding the compressed video data;
converting the data video data expanded by the expanding unit into a predetermined format;
writing synchronization information into the compressed audio data, the synchronization information to synchronize the converted video data; and
multiplexing the converted video data and the compressed audio data in which the synchronization information is written, to generate stream data.

14. The computer-readable recording medium according to claim 13, wherein the synchronization information includes information indicative of reproduction start timing of the compressed audio data.

15. The computer-readable recording medium according to claim 13, wherein the synchronization information includes time stamp information indicative of reproduction start timing of the compressed audio data.

16. The computer-readable recording medium according to claim 13, wherein the multiplexing program further makes the computer execute producing the stream data while synchronizing the converted video data and the compressed audio data multiplexed in the stream data based on the synchronization information.

17. The computer-readable recording medium according to claim 14, wherein the multiplexing program further makes the computer execute reproducing the stream data while synchronizing the converted video data and the compressed audio data multiplexed in the stream data based on pause information indicative of the reproduction start timing.

18. The computer-readable recording medium according to claim 15, wherein the multiplexing program further makes the computer execute reproducing the stream data while synchronizing the converted video data and the compressed audio data multiplexed in the stream data by calculating time difference between reproduction start timing of the converted video data and the reproduction start timing of the compressed audio data, based on the time stamp information.
